(19) United States
(12) Patent Application Publication
(10) Pub. No.: US 2019/0061137 A1
(43) Pub. Date: Feb. 28, 2019

(54) UPRIGHT ATTACHABLE HANDLE FOR HOUSEOLD KNIVES

(71) Applicants: Rebecca Cooney, Ottawa (CA); Robert Platts, Ottawa (CA); Andrew Katz, Ottawa (CA)

(72) Inventors: Rebecca Cooney, Ottawa (CA); Robert Platts, Ottawa (CA); Andrew Katz, Ottawa (CA)

(21) Appl. No.: 15/687,213

(22) Filed: Aug. 25, 2017

(51) Int. Cl. B25G 1/10; B26B 3/02

(52) U.S. Cl. CPC B25G 1/102; B26B 3/02

(57) ABSTRACT

Upright handgrip integral with nutcracker-like clamping mechanism for attachment to handles of household knives to allow those with wrist and hand strength or control problems to use their preferred knives safely and effectively. Grips near the back of a knife handle with deformable and tailorable elastomer pads, and to the knife blade itself just ahead of the handle, to complete the attachment and prevent twisting or flexing in use.

### TECHNICAL FIELD

This invention relates to providing an upright handgrip attachable to household knives.

### BACKGROUND OF THE INVENTION

The common household knife can be difficult and unsafe to use by people troubled with reduced wrist and hand strength or control. Accordingly, a few manufacturers offer knives made with upright handles that are much more usable for such people. These single-purpose knives are expensive, however, and several would be required to serve the various kitchen needs—butcher knife, bread knife for example. Further, most households already have several favorite knives on hand—at least one for each function. Often these knives are part of an expensive set, or are treasured heirloom pieces.

The object of the present invention is to provide an upright handgrip device easily attachable to and detachable from most household knives despite the varied size and shape of their handles, yet attaching rigidly enough to keep the knife from twisting or slipping in forceful cutting, enabling use of each knife as is or with the upright handgrip.

### SUMMARY OF THE INVENTION

The invention, an upright handle integral with attachment means for kitchen knives and other such knives, is comprised of: an upright handgrip mounted atop an horizontal clamp device formed as a channel of about the length of a common knife handle, the vertical web and top and bottom flanges of the channel being larger than respectively the depth and width of the knife handle; an end wall extending sideways from the front end of the vertical web to reach almost halfway across the width of the channel flanges; a side plate of similar dimensions as the vertical web hingedly attached along the edge of the bottom flange of the channel, so that the side plate can lie open to enable lengthwise placement of the knife within the channel, with the knife blade forward and cutting edge down, and with the far side of the knife blade, just ahead of the knife handle, resting against the vertical edge of the first end wall; a second end wall at the front end of the hingedly attached side plate, sized so that its edge closes against the near side of the knife blade, across from the first end wall, when the side plate is rotated upward to close the channel to enclose and hold the knife handle; elastomeric pads inside the channel near the rear, secured to the channel's bottom and top flanges and vertical web of the channel, and to the inner side of the side plate there, formed to press firmly against the top, bottom and sides of the knife handle near its rear, regardless of the shape and size of the knife handle there, when the side plate is rotated upward; elastomeric edgings secured to the vertical edge of preferably each end wall, formed to press firmly against the sides of the knife blade just ahead of the handle; preferably a thin elastomeric strip lining the underside of the top flange of the channel; an arm extending from the free upper edge of the hingedly attached side plate, the arm being positioned so that hand-forcing it upward closes the side plate up and against the exposed side of the knife handle with considerable leverage; a groove formed up the side of the handgrip into which the arm closes; a spring clip or snap fastener at the top of the arm to secure the arm to the handgrip and complete the clamping of the upright handgrip device to the knife.

### BRIEF DESCRIPTION OF THE DRAWINGS

FIG. 1 is a plan view of the upright handgrip device lying on its side and opened to receive a kitchen knife, the knife already laid in it.

FIG. 2 is a perspective view of the device, still on its side.

FIG. 3A is a side elevation of the device installed on the knife.

FIG. 3B is a cross section of the front of the device closed on the knife blade.

### DETAILED DESCRIPTION OF THE INVENTION

Terms: “Channel” is used here as in the establshed structural term “steel channel”, as are its parts, “web” and “flange”. “Handgrip” is used simply to designate the handle of the device as distinct from from the knife handle itself. “End wall” means a plate extending one way from an end of a longitudinal plate (web or side plate, here), at right angles to it. “Elastomeric” denotes a visco-elastically deformable material such as a foam rubber.

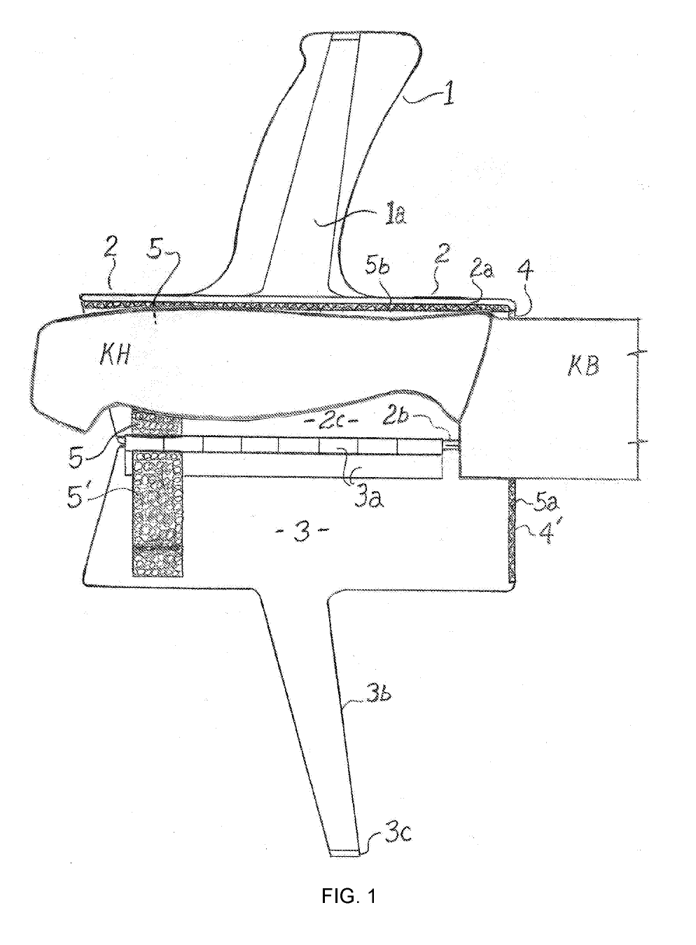

FIG. 1 shows the upright handgrip device lying wide open ready to clamp to an example knife KH-KB. (While the device would preferably be lying flat on a table at this point, for consistency all will be described as if the handgrip is vertical and the knife KH-KB poised as if ready for use, cutting edge down.) The handgrip 1 is integral with a channel 2, which partially encloses the knife handle KH inside the channel's top and bottom flanges 2a and 2b and its vertical web 2c; these and much of the following are more clearly shown below. A hinged side plate 3 is shown opened wide on its hinge 3a attached to the outer edge of flange 2c, and the side plate 3 extends into a lever arm 3b. A clip or snap type of fastener 3c is set at the top of the arm 3b. A first end wall 4 extends at right angles from the web 2c almost halfway across the width of the flange 2a, to bear against the far side of the knife blade KB, and a second end wall 4′ extends from the end of the side plate 3, ready to be brought to bear against the near side of the knife blade. Elastomeric pads 5 are fixed to the web 2c and the flanges 2a and 2b, and elastomeric pads 5′ are fixed to the side plate 3 respectively, to be brought to bear against the knife handle KH, able to squeeze and hold handles of varying cross section. Thin elastomeric edgings 5a line the vertical edges of 4 and 4′ to help squeeze onto and hold knife blades of varied thickness. A thin elastomeric lining 5b may further help vertically secure knife handles of some shapes, and help avoid any marring of the knife. A groove 1a is formed in the handgrip 1 to receive the lever arm 3a.

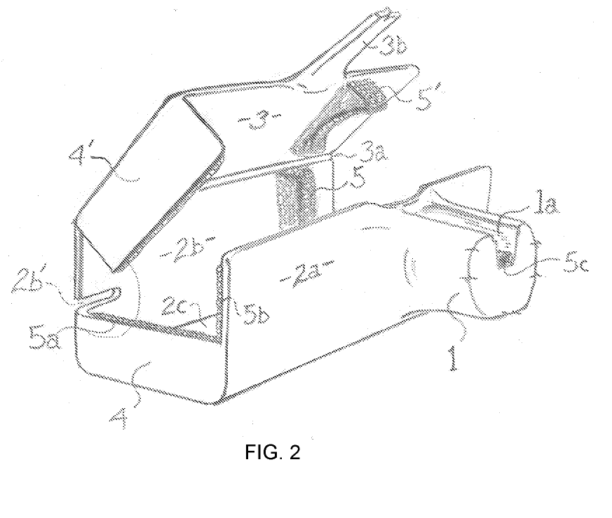

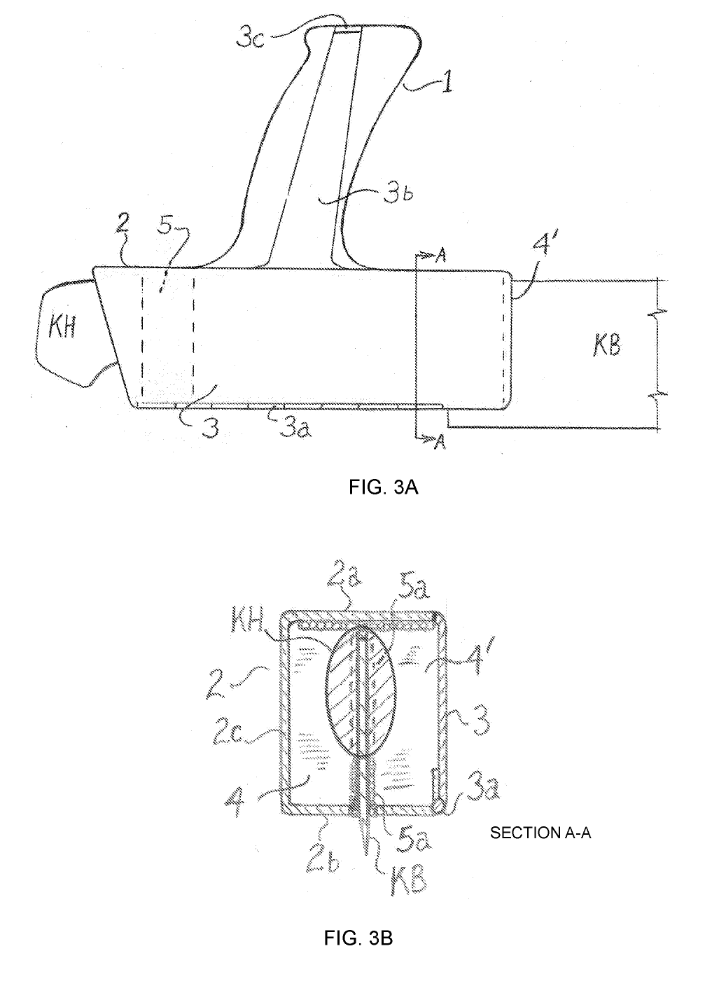

In the FIG. 2 sketch, the upright handgrip device is shown partly open—and empty, for clarity—mainly to illustrate the nutcracker-like function of the lever arm 3a in closing the end walls 4 and 4′ where the knife blade will lie, as well as the closing of the elastomeric pads 5 and 5′ where the rear of the knife handle will lie. Knife handles may protrude forward over the blade, so the knife must be moved back; therefore a slot 2b′ is provided in the flange 2b to accomodate deeper blades. (FIG. 1, FIG. 3A and FIG. 3B show such a handle and blade configuration KH-KB but cannot show the slot 2b′.) Also shown in FIG. 2 is a preferred use of the groove 1a for storing extra elastomeric pads 5c under the closed position of the lever arm 3b; such pads, perhaps adhesive-backed, may be useful for thickening portions of the elastomeric pads 5 and 5′ to clamp onto especially small handles.

FIG. 3A shows the upright handgrip device secured to the knife KH-KB. The user need not press hard, the closing force on the top of the lever arm 3a being multiplied about tenfold against the middle height of the knife handle KH, in this example. Similarly, the fastening clip or snap 3b need not be very strong and can be easily opened for changing knives.

FIG. 3B more clearly shows how the end walls 4 and 4′ close against the knife blade KB to prevent twisting or vertical movement of the knife blade relative to the upright handgrip device.

Materials may be metal—preferably aluminum alloy—or fiber-plastic composites for the handgrip and channel part, and metal for the side plate and lever arm part.

Various modifications can be made to this invention without departing from the apparent scope hereof. Examples: the channel part together with the side plate may be formed as an 0 in cross section; the clip or snap might be a hook or even “velcro” pieces; elastomer coatings may be used over more of the interior of the channel and side plate to further ensure the knife will not be marred.

We claim:

1. An upright handgrip integral with a clamp-like base enabling attachment to almost any kitchen knife to improve its usability, the apparatus comprising:
an upright handgrip mounted atop an horizontal channel of about the length of a common knife handle, the vertical web and top and bottom flanges of the channel being larger than respectively the depth and width of the knife handle;
a first end wall extending sideways from the front end of the vertical web to reach almost halfway across the width of the channel flanges;
a side plate of the same height and length as the vertical web hingedly attached along the edge of the bottom flange of the channel;
a second end wall extending sideways from the front end of the hingedly attached side plate to be able to reach across almost half the width of the bottom flange;
elastomeric edgings secured to the vertical edge of each end wall, formed to press firmly against the sides of the knife blade just ahead of the handle;
elastomeric pads inside the elongated channel near the rear, secured to the bottom and top flanges and vertical web of the channel;
elastomeric pads secured to the inside of the side plate near the rear, positioned directly across from those in the channel;
preferably a thin elastomeric strip lining the underside of the top flange of the channel;
a lever arm extending from the free upper edge of the hingedly attached side plate;
a groove formed up the side of the handgrip into which the lever arm can be set;
a spring clip or snap fastener at the top of the lever arm to easily hand-secure the arm to the handgrip;
wherein the side plate firstly lies open to enable lengthwise placement of the knife handle within the channel, with the knife blade forward and cutting edge down, and with a first side of the knife blade just ahead of the knife handle resting against the elastomer edging of the first end wall; then the lever arm is rotated upward to close the side plate up against the exposed side of the knife handle with considerable leverage, pressing the elastomeric edging of the second end wall against the side of the knife blade to squeeze it against the elastomeric edging of the first end wall, and pressing the elastomeric pads on the side plate against the rear of the knife handle to squeeze it against and into the elastomeric pads set in the channel; finally the now-upright lever arm is pushed into the groove on the handgrip, engaging the spring clip or snap fastener and so completing the attachment of upright handgrip to the knife—while leaving it easily detachable to be used with other knives.
